(19) United States
(12) Patent Application Publication
(10) Pub. No.: US 2011/0284690 A1
(43) Pub. Date: Nov. 24, 2011

(54) Utility Device System For Releasing Or Capturing Disbursements For The Atmosphere By Means Of An Aircraft

(76) Inventor: Alexander M. Puckett, Salem, VA (US)

(21) Appl. No.: 13/081,816

(22) Filed: Apr. 7, 2011

(51) Int. Cl. B64C 1/00; A01G 15/00

(52) U.S. Cl. 244/129.1; 239/14.1

(57) ABSTRACT

An aircraft carrying oxygen, gases, and/or fluid advancement tanks is flown to heights greater than ground level and released out to the atmosphere, or gathered in tanks contained in the fuselage. The system is regulated by the atmospheric height or by an attendant such as the pilot or automation on the aircraft. The device includes a supply of oxygen, gases, and/or fluid advancements tanks, release or capture device, hoses, hose regulators and a relay switch. The idea here is to equip all aircraft with this utility system of oxygen, gases, and/or fluid advancement tank capabilities. As each aircraft flies to its intended destination, it helps the environment by feeding oxygen, gases, and/or fluid advancements into the atmosphere to promote cleaner, clearer, better-used atmospheric layers and maintained surface viabilities.

### FIELD OF THE INVENTION

The present invention is generally directed to adding oxygen out to the atmosphere for the promotion of ozone replenishment. The present invention is specifically directed to adding assortments by use of aircraft carrying tanks which release or capture attributes out to the atmosphere at heights greater than ground levels.

### DESCRIPTION OF THE PRIOR ART

There is a tremendous awareness that more must be done to protect all life on earth from damage caused by the sun or earthly actions that contribute benign or malignant debris. The technology and solutions to correct the issue are of specific interests. Specific interests contained herein are systems and inventions directed to the repair and maintenance of acceptable atmospheric layer manipulations as needed.

The problems and shortcomings with today's technologies are that modern mechanical solutions do not fully correct the issue of global warming. These technologies are not capable of being used repeatedly for maximum use and effectiveness. These technologies do not settle airborne particles quickly enough to make a difference today by absorbing the impacts of various exhausts. These technologies are of concern because the feasibility and practicality of the inventions make them unsatisfactory, impractical, and unsafe. In other words, the trade-off between practicing these inventions and the rate of return to accomplish an increase of atmospheric protection is sub-standard or sparsely identified. And, they do not generate the financial resources from continued use through sales and new jobs pertinent for today's economy. In fact, there is an excise tax placed on businesses that use ozone depleting molecules.

Studies have determined that chlorofluorocarbons (CFCs), nitric oxide, methane, and other molecular structures will continue to rise for the next 100 years and longer. While most altered or altering molecules will be variably and continuously disbursed continually through time, further affecting the free oxygen content of the upper atmospheres; it is here in the upper atmospheres where higher oxygen content is needed to protect the earth from ultraviolet (UV) rays. Awareness policies and actions on the ground to correct the issue of CFC's and excess airborne contaminants that impact our ecological environments are contributing efforts. They are not yet the most direct or effective cure. These policies seek to slowly reverse the direction at which we are advancing towards for the stabilization that oxygen and assortments can continuously provide when used in the correct capacities. Alternatively, the practices to ease, assist, or reverse the impact of global warming or airborne debris contaminants from the ground are hardly effective. This is due to the sheer mass of molecular alterations (“Pollution”) contributed by humans and animal life, plumes of ash and gases from eruptions, magnifications from power exhaust, pollinations, lack of or over-casting of rainfall, malicious acts, or accidents that challenge safety practices.

Thus, there is a need to provide an adequate system for repairing, strengthening, or widening of the earth's ozone layer. There is a need to suppressing airborne debris. There is a need for developing agricultural pollinations with a high volume of dispersion and ease of management. And there is an abundance of potential for inducing a utility system for aircraft to release or capture airborne mixtures for atmospheric management.

### SUMMARY OF THE INVENTION

The general purpose of the present invention has to do with ecology. Specifically, the purpose detailed in this draft is to replenish distilled or naturally occurring and collected oxygen.

This invention directly distributes oxygen and molecular technologies out to the atmosphere by aircraft for the promotion of ozone replenishment to further protect against UV rays. Or on the inverse, this invention also seeks to capture and contain atmosphere and debris for distillation and assessment to ease the reflections and magnifications of UV rays.

This invention may also be used for other purposes as touched-on or intuitively comprehended throughout the writing for the application of achievements in our world by science and technology. In essence, this invention is used for managing our atmospheres against any further intrusion of UV light; to molecularly alter or contain gases that deplete ozone levels like nitric oxide, methane, chlorofluorocarbons, etcetera with gas or fluid exchanges; and in general by further protecting life sources from complete annihilation. There is an allowance sought for air-height released technologies that allow for maintenance or degradation abilities to be applied to or for storm-weather related incidents such as hurricanes and tornados, not otherwise known.

This utility to manage our atmosphere is comprised of collecting gases and fluids occurring naturally, distilled, and/or processed in facilities. These gases and fluids are transported to aircraft capable of flight, loaded or off-loaded in the aircraft, connected to the release or capture devices, and the molecular manipulators are dispersed or collected at desired heights in designated space.

The utility process involves the use of aircraft carrying oxygen, gases, and/or fluid advancement tanks 4, 4A that are fed through regulators 2, 2A by hoses 3 triggered with a relay switch 5 that opens the atmospheric release device 1, 1A. The oxygen, gases, and/or fluid advancements contained in the tanks 4, 4A is released or captured at desired or predetermined heights for maximum efficiency and effectiveness to the exterior atmosphere around the aircraft.

The system includes a supply of storage tanks 4, 4A, a release/capture valve 1, 1A, hoses 3, regulators 2, 2A, and a relay switch 5 operated by the attendant, pilot, or automation. As each aircraft flies towards its intended destination, the system helps the environment by feeding or capturing oxygen, gases, and/or fluid advancements out to or in from the atmosphere.

The basic attributes and features of the invention are an exterior release or capture point device 1, 1A on the front, side, or the rear of a plane that is connected to internal dispensing or collection regulators 2, 2A attached to tanks 4, 4A of oxygen, gases, and/or fluid advancements by hoses 3 and released by use of the relay switch 5. Or an exterior capture point device 1A attached to a compressor 2A with hoses 3 that potentially fill an empty collection tank 4A by means of a relay switch 5.

It is within the scope of this invention to have additional replacement tanks 4, 4A on the aircraft as necessary.

### Advantages:

Photolysis is the process by which molecular bonds between atoms are split to produce other molecules or singular atoms sometimes referred to as free-radicals. Free-radicals are atoms that want to bond with other atoms or molecules. The upper stratosphere is the direct layer where photolysis is preferable for oxygen to promote ozone production and potential management. It is here where photolysis preferably splits oxygen (O₂) molecules to individual atoms, free-radicals (O1), for the promotion of bonding with other oxygen (O₂) molecules to form the ozone (O₃) molecule. (O1−O1=O2.) Split one bond, produce two ozone molecules. 2(O1+O2=O3=O1−O1−O1.) This is the preferable bonding as CFCs, nitric oxide, methane, etcetera bond with the oxygen free-radicals; thereby obstructing our abilities to maintain a stable ozone layer.

Advantageously, the present invention provides a safe and effective way to re-supply oxygen to the upper atmospheres.

This invention is also a safe way to release or capture chemicals in gas or fluid form to aid with the breakdown of molecules that destabilize the ozone layer like methane, nitric oxide, CFC's, etcetera, at heights greater than ground level.

Therefore, the present invention is designed for the promotion of ozone protection or continuity of surface expectations to all environments and living beings on earth and may be used for deterrents, additions, rations, solutions, and more.

The objects and uses of the invention will appear more fully from the following detailed description of the preferred embodiment of the invention made in conjunction with the accompanying drawings.

### BRIEF DESCRIPTION OF THE DRAWINGS

FIG. 1 illustrates the side view of an aircraft which includes the system and alternate form of the present invention.

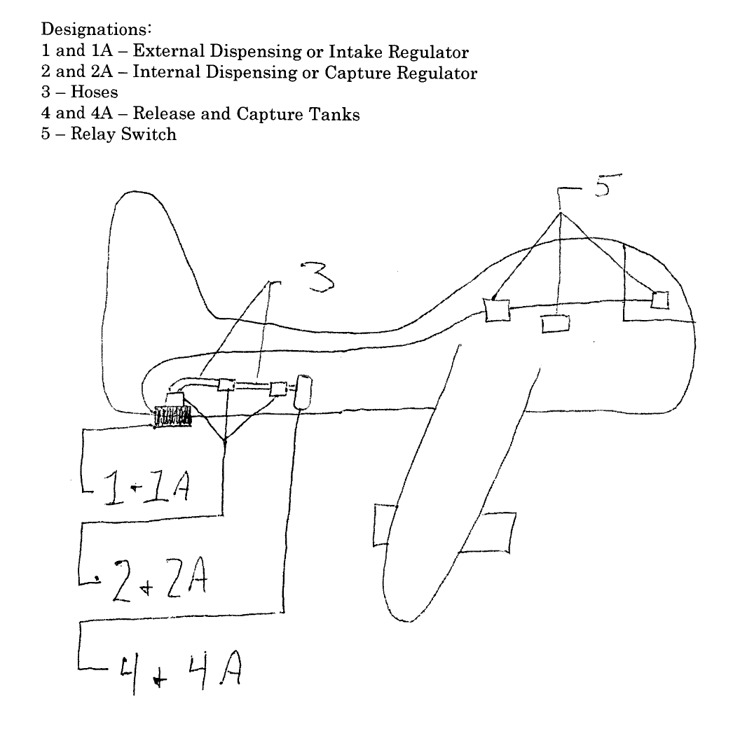

### DETAILED DESCRIPTION OF THE INVENTION

The present utility invention is directed to the concept and available or eventual truth of an aircraft which carries oxygen, gases, and/or fluid advancements tanks 4, 4A for disseminating oxygen, gases, and/or fluid advancements to the atmosphere. The basic attributes and features of the invention are:
An aircraft customized to incorporate the system of the present invention by;
An exterior release or capture point device on the rear, side, or front of the aircraft as appropriate to the needs of the system 1, 1A;
An internal dispensing or capture regulator(s) 2, 2A;
A hose or hoses connecting the tanks and internal dispensing or capture regulators 3 and the exterior release or capture device;
A potential for tank connection adapters should the hoses require fitting to foreign tank valves (U.S. codes and regulations dictate that all oxygen tanks have the same metered release valve specifications.);
A release valve connection on the oxygen, gases, and/or fluid advancements tank 4, 4A;
A relay switch that activates the exterior release or capture, dispensing or intake regulator, point device 5; and,
One or more tanks of oxygen, gases, and/or fluid advancements, or empty tanks for capture; including additional replacement tanks as necessary 4, 4A.

The regulators 2, 2A and release or capture devices 1, 1A connect for the outflow or intake process of oxygen, gases, and/or fluid advancement tanks 4, 4A through hoses 3 with a relay switch 5 to be operated when a desired height is reached. Oxygen, gases, and/or fluid advancements are then disbursed out to the exterior atmosphere of the aircraft, or captured during flight. The utility device system is to be operated by an attendant, pilot, or automation on the aircraft by means of the relay switch 5.

### Aircraft:

It is within the scope of this invention to use any type of available aircraft, including but not limited to commercial and private airplanes, jets, dirigibles, and the like.

### External Dispensing or Intake Regulator 1, 1A:

A dispensing regulator unit is to be installed with the expulsion side on the exterior of the plane out of range of air currents to the main engine intakes, and out of range of the aerodynamics that could draft the oxygen from the tanks to the auxiliary power unit (APU), located on some planes in the tail section. The dispensing regulator unit is to be hermetically sealed between the exterior portion of the fuselage and the interior of the fuselage. It is to be fastened to the fuselage with glue, solder, weld, bolts and screws, or with a combination of these sealers. This will likely ensure that cabin pressure remains constant and air or fluids do not seep in to or out of the plane at this location. (The regulator will be fully sealed as one unit to halt any possibility of a leak from the external atmosphere in to the interior of the aircraft or out in to the atmosphere.) With these safety measures in place, the pressure of the oxygen, gases, and/or fluid advancements outflow is to keep the valve open after flipping the relay switch by the pilot, attendant, or automation. If a valve does not close properly once the tanks are empty, the system would have been checked and is built to prevent leaks so integrity should not be compromised. It is also within the composition of this draft for the invention to include a fluid release valve. (The release valve could be installed on the fuselage, on a wing, in an access door, through a window . . . something “easily” replaceable.)

The external dispensing regulator parts are to be made of non-conductive metal as a means of ionic protection to ensure safety and integrity of the aircraft and all its parts as a whole. All the parts of this device should be capable of withstanding temperature variations with the possibility of a temperature adjustment enclosure regulating system being included to avoid apparatus seizure from excessive cold or heat.

### Internal Dispensing or Capture Regulators 2, 2A:

A technology for these regulators has been known for some time and allows for the middle output-point connection between the tubing and the external dispensing regulator to stop outflow once tank pressure has lessened. This is due to the one-way directional forced-flow design and construction of release regulators. This is a direct precaution measure to prohibit backflow in to the system and/or aircraft once the pressure from dispensing lessens. These parts could possibly be made of non-conductive metal as well for ionic protection and capable of withstanding temperature variations. These parts may even be included as the actual release point with a secondary and tertiary regulator being used for safety.

Capture Regulators are capable of filling tanks with pressurized gas gathered from the exterior atmosphere by a compressor while the plane is in flight and only flow one-way.

### Hoses 3:

Hosing is attached to the internal dispensing regulator units and the oxygen, gases, and/or fluid advancements tanks. These should be a special variety that is reinforced for safety and able to withstand temperature variations with the connection points' and lengths properly and thoroughly checked and rechecked for leaks or faulty connections. These hoses could be made of metal as seen in many applications for compressed materials or more tensile for movement of the tanks as sometimes required for space management and/or balance. The hose quality and tensile strength are an additional safety measure in prohibiting exterior atmospheric air from entering the aircraft. They also allow for freedoms-from-worry should a leak occur internally during flight that would keep the release valves closed, given that any materials handled on boarding would have been pre-certified and/or checked.

Oxygen, Gases, and/or Fluid Advancements Tank 4, 4A:

An oxygen, gases, and/or fluid advancement tank can vary to any size and are to be replaced once emptied or filled by ground crew, before or after flight. It is within the scope of the present invention to add this task to the pre-flight checklist to ensure proper use and workings of the system.

The system may also require a box of adapters to aid hook-ups for tanks built to different specifications by international countries. As noted within this draft, U.S. code states and is truth that all gaseous storage containers are built and sold with the same specifications. International travel could benefit substantially by carrying the replacement tanks for return flights from original destination countries as outlined with in this formal application.

An additional tank-to-tank connection could be included in the event that fluids are in need of pressurized gas to induce expulsion.

Empty tanks for collection should be of, or painted and maintained with, a material that prohibits rusting or corrosion.

### Relay Switch 5:

A relay switch is the activation point for the pilot, attendant, or automation to open the external dispensing or collection regulator once desired height is reached. It may be operated as simply as a wire-to-catch, a spark, or by another method deemed safe and appropriate by transportation safety administrators. The Relay Switch may be activated by a switch, dial, or another method desired or developed.

### Betterments:

All components may be changed periodically, with substitutions to keep up with technology or for more efficient uses of the system, to ensure proper safety and continued use.

So it should be known and understood that the invention is not confined to the particular construction and arrangement of parts herein illustrated and described, but embraces such modified forms thereof as come within the scope of the following claims.

What is claimed:

1. A system for expelling oxygen, gases, and/or fluid advancements from an aircraft into the atmosphere, the system comprising of:
A. An aircraft customized to incorporate the system of the present invention by;
B. An exterior release point device on the aircraft;
C. An internal dispensing regulators;
D. A hose or hoses and/or tubing connected to the internal dispensing regulators;
E. A box of adapters should the tubing require fitting to “foreign” tank valves;
F. A release valve on the oxygen, gases, and/or fluid advancements tank(s);
G. A relay switch or knob that activates the exterior release regulator device;
H. One or more tanks of oxygen, gases, and/or fluid advancements, including additional replacement tanks as necessary.

2. The system of claim 1 wherein the aircraft is selected from the group consisting of commercial and private airplanes, jets, dirigibles, and the like.

3. The system of claim 1 wherein the oxygen, gases, and/or fluid advancements is expelled into the atmosphere at heights greater than ground level.

4. The system of claim 1 wherein the system is operated by an attendant, such as the pilot, on the aircraft; or by automation.

5. The system of claim 1 wherein the dispensing regulator unit is hermetically sealed (glued, soldered, welded) to the plane with the potential to also be fastened with bolts or screws.

6. The system of claim 1 wherein the dispensing regulator is installed with the expulsion side directed to flow towards the exterior atmosphere surrounding the aircraft.

7. The system of claim 1 wherein the pieces of the exterior release point device are non-conductive for ionic protection.

8. The system of claim 1 wherein the oxygen, gases, and-or fluid advancements are non-flammable as best they can be.

9. The system of claim 1 wherein the inverse of the expulsion system is instituted for the intake collection of atmospheric gases or fluids for analysis and/or distillation.
